(19) United States
(12) Patent Application Publication
(10) Pub. No.: US 2007/0234335 A1
(43) Pub. Date: Oct. 4, 2007

(54) Software component management apparatus and method

(75) Inventors: Yoshihiro Takahashi, Tokyo (JP); Nobuyuki Ikeda, Tokyo (JP); Hirotaka Toya, Kanagawa-ken (JP); Ikuko Osajima, Kanagawa-ken (JP); Katsumasa Jin, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-Ku (JP)

(21) Appl. No.: 11/500,938

(22) Filed: Aug. 9, 2006

(30) Foreign Application Priority Data
Mar. 8, 2006 (JP) 2006-062417

(51) Int. Cl. G06F 9/44

(52) U.S. Cl. 717/168

(57) ABSTRACT

A component record unit records a plurality of software components each having an essential part and a supplemental part. A user-side software record unit records a plurality of user-side softwares each related to at least one software component recorded in the component record unit. A registration-update unit decides whether a modification part of a software component recorded in the component record unit is the essential part or the supplemental part, and updates information of at least one of the component record unit and the user-side software record unit based on a decision result. An information notification unit notifies the modification part to the user-side software related to the software component modified if the modification part is the essential part.

### CROSS-REFERENCE TO RELATED APPLICATIONS

This application is based upon and claims the benefit of priority from prior Japanese Patent Application No. 2006-062417, filed on Mar. 8, 2006; the entire contents of which are incorporated herein by reference.

### FIELD OF THE INVENTION

The present invention relates to a software component management apparatus and a method for managing registration and update of a software component used by a user-side software.

### BACKGROUND OF THE INVENTION

Recently, as development form or application style of a system using a software, the software divided by a suitable unit is regarded as a component (Hereinafter, the divided software is called a software component). By combining a plurality of software components developed, new software is effectively created and applied.

As a system to register, a software component management apparatus manages and provides such software component.

In a user-side of the software component, the user-side receives provision of one or a plurality of software components by the software component management apparatus. By combining a plurality of the software components provided, or by installing a software module (originally developed by the user-side) into the software component, new software of the user-side is constructed.

In general, a plurality of software components exists and a plurality of user-side software also exists. Accordingly, in the software component management apparatus, a function to concentrically manage which user-side software uses (installs) a software component provided is necessary.

Furthermore, in case of finding a defect (such as a bug) in a predetermined software component or in case of modifying (upgrade or version-up) a predetermined software component, it is necessary to notify the bug or the version-up to another user (another user-side software) who utilizes this software component

In order to satisfy such request, JP-A No. 2001-282519 (Kokai) (Hereinafter, a reference 1) is known. In a software component management apparatus of the reference 1, software component management information, user-side software information, and link information relating the software component management information with the user-side software information, are registered. All user-side software using the predetermined software component is retrieved, and bug information or the modification is notified to all user-side software retrieved.

Nowadays, a software component provided from the software component management apparatus is often represented as source code. Accordingly, in the user-side, this original software component can be easily modified (changed) as new software component suitable for the user-side software.

This modification is not always a modification of an essential part of the software component, but a modification of a supplemental part such as error-correction processing or parameter adjustment of input/output data.

In this way, in each user-side software, many software components of “branch” having a supplemental part different from an original software component of “base” exist.

In the background art, the user-side software often manages the software component of “branch” (management of a modification history). In other words, a provision source-side of the original software component does not concentrically manage the modification history of the software component provided.

In this case, even if a modification of the software component by the user-side is change of an essential part of the software component (For example, function extension or defect elimination in the essential part), users except for an author of the original software component cannot understand effect or level that the change causes another user-side software. As a result, it is difficult to suitably notify the modification to another user-side software.

On the other hand, if a modification of the software component by some user-side software is notified to all other user-side software without distinction of the essential part and the supplemental part, another user-side software (received a notification of the modification) may execute unnecessary modification of the software component. As a result, such notification of the modification rather causes a bad influence.

### SUMMARY OF THE INVENTION

The present invention is directed to a software component management apparatus and a method for effectively managing a modification of the software component by discriminating an essential part and a supplemental part of the software component.

According to an aspect of the present invention, there is provided an apparatus for managing a software component, comprising: a component record unit configured to record a plurality of software components, each software component having an essential part and a supplemental part; a user-side software record unit configured to record a plurality of user-side softwares each user-side software being related to at least one software component recorded in said user-side software; a registration-update unit configured to decide whether a modification part of a software component recorded in said component record unit is the essential part or the supplemental part, and to update information of at least one of said component record unit and said user-side software record unit based on a decision result; and an information notification unit configured to notify the modification part to the user-side software related to the software component modified if the modification part is the essential part.

According to another aspect of the present invention, there is also provided a method for managing a software component, comprising: recording a plurality of software components, each software component having an essential part and a supplemental part; recording a plurality of user-side softwares, each user-side software being related to at least one software component recorded; deciding whether a modification part of a software component recorded is the essential part or the supplemental part; updating at least one of the plurality of software components and the plurality of user-side softwares based on a decision result; and notifying the modification part to the user-side software related to the software component modified if the modification part is the essential part.

According to still another aspect of the present invention, there is also provided a computer readable medium having a software component comprising: a source code having an essential part and a supplemental part; and a mark information added to the essential part and the supplemental part for causing a computer to discriminate between the essential part and the supplemental part.

### BRIEF DESCRIPTION OF THE DRAWINGS

FIG. 1 is an application concept of a software component management apparatus.

FIG. 2 is a system construction of a software component management apparatus.

FIG. 3 is one example of a source code of a software component.

FIG. 4 is a flow chart of processing of a software component management method.

FIG. 5 is a schematic diagram of first operation in case of updating the software component of which supplemental part is changed.

FIG. 6 is a schematic diagram of second operation in case of updating the software component of which supplemental part is changed.

FIG. 7 is a schematic diagram of first operation in case of updating the software component of which essential part is changed.

FIG. 8 is a schematic diagram of second operation in case of updating the software component of which essential part is changed.

FIG. 9 is a schematic diagram of third operation in case of updating the software component of which essential part is changed.

### DETAILED DESCRIPTION OF THE EMBODIMENTS

Hereinafter, various embodiments of the present invention will be explained by referring to the drawings. The present invention is not limited to the following embodiments.

(1) Construction of the software component management apparatus

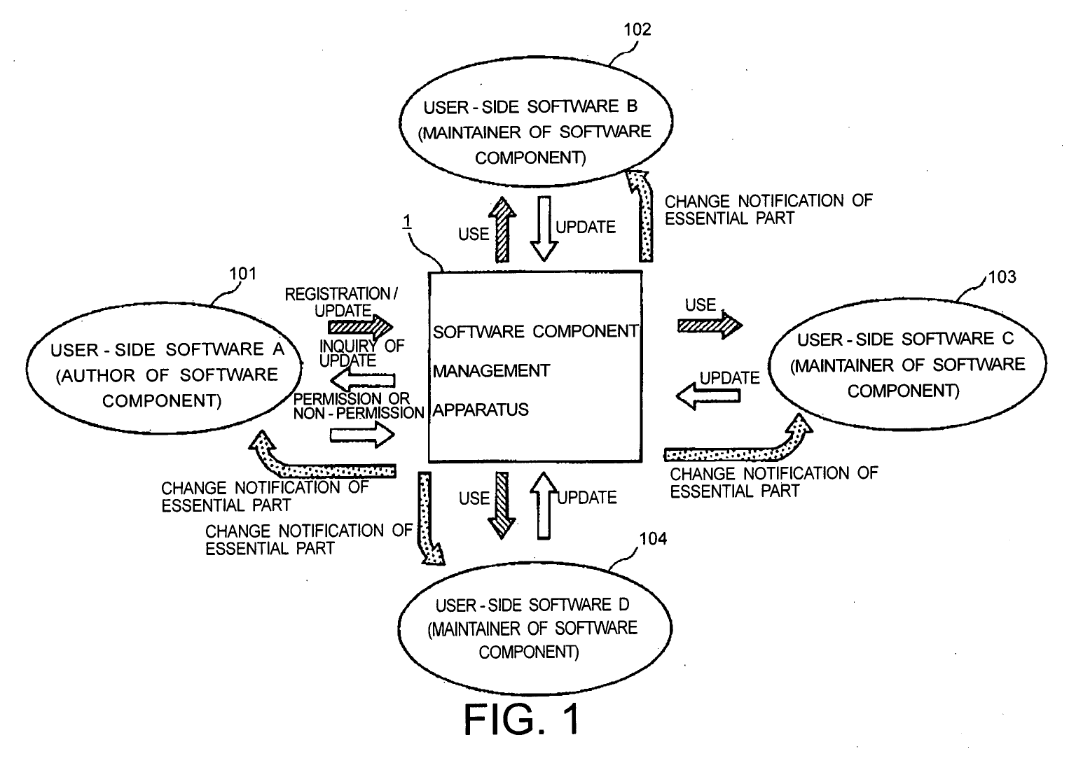

FIG. 1 is one example of application concept of the software component management apparatus 1 of one embodiment.

In the software component management apparatus 1, a software component created by a user, and a system using the software component (Hereinafter, this system is called a user-side software), are registered. Furthermore, the software component registered is provided to another user (another user-side software) in order to effectively utilize a software resource.

For example, the software component management apparatus 1 is one kind of a server apparatus. As a hardware construction, a control apparatus having a CPU, a memory apparatus having a HDD, and an input/output apparatus for sending/receiving data via an electric communication circuit (such as LAN) or a memory medium are prepared.

In the software component management apparatus 1 of the present embodiment, registration of a software component newly created and management of provision of the software component are executed. Furthermore, in case of modifying the software component (version-up), update-registration of the software component modified is executed (Hereinafter, it is called “update”). Modification history of the software component is also managed.

Modification of the software component is executed by not only an author of the (original) software component (In FIG. 1, a maintainer of the user-side software A) but also other users (In FIG. 1, maintainers of the user-side software B, C, and D) except for the author under a predetermined condition.

As explained afterwards, in case of modifying (changing) an essential part of the software component, a notification that the essential part of the software component has been modified is sent to all user-side software which use this software component. In this case, when a user (maintainer) of the user-side software B, C, and D modifies an essential part of the software component, an inquiry to permit modification of the software component is sent to an author of this software component. If a permission of modification of the software component is received from the author, this software component is updated (modified).

In FIG. 1, a maintainer of the user-side software A is an author of a software component. After registering the software component to the software component management apparatus 1, other maintainers (users) of the user-side software B, C and D utilize this software component. However, the number of user-side software accessing to the software component management apparatus 1 is not limited to four in FIG. 1. Furthermore, creation/registration of new software component can be executed from the user-side software B, C, and D.

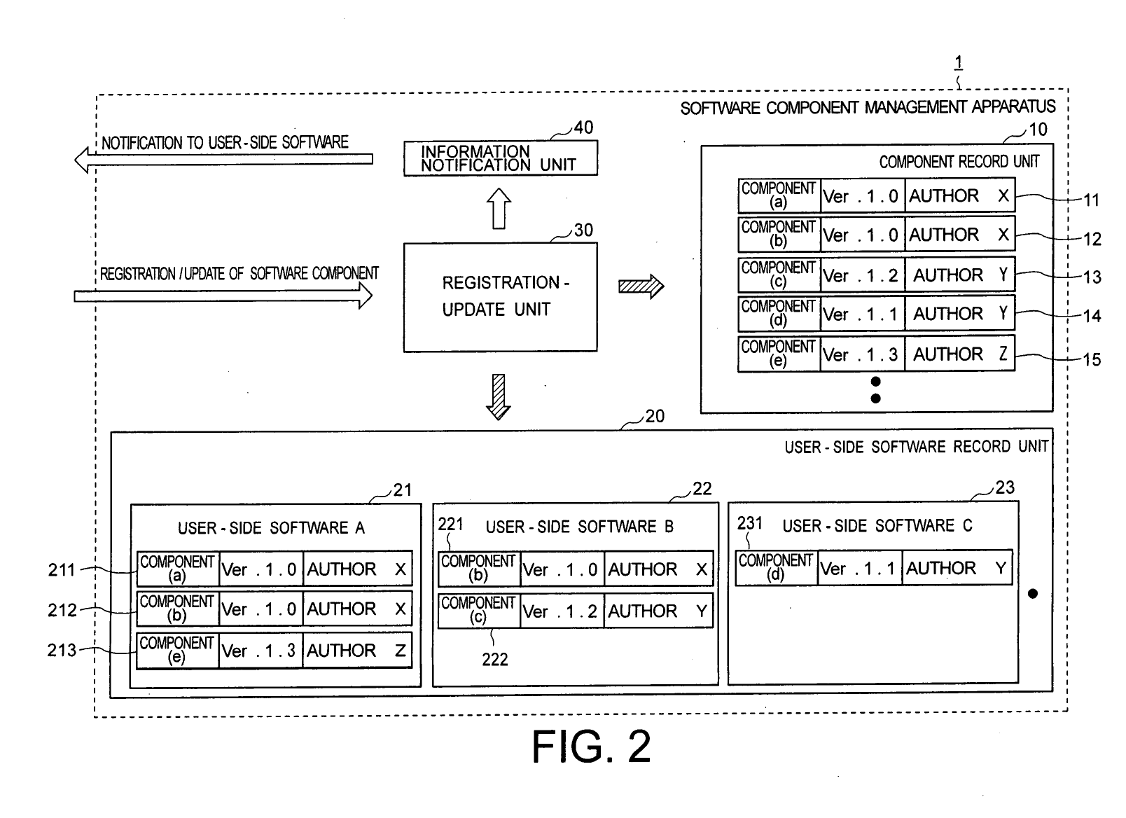

FIG. 2 is a block diagram of system-construction of the software component management apparatus 1. The software component management apparatus 1 includes a component record unit 10, a user-side software record unit 20, a registration-update unit 30, and an information notification unit 40.

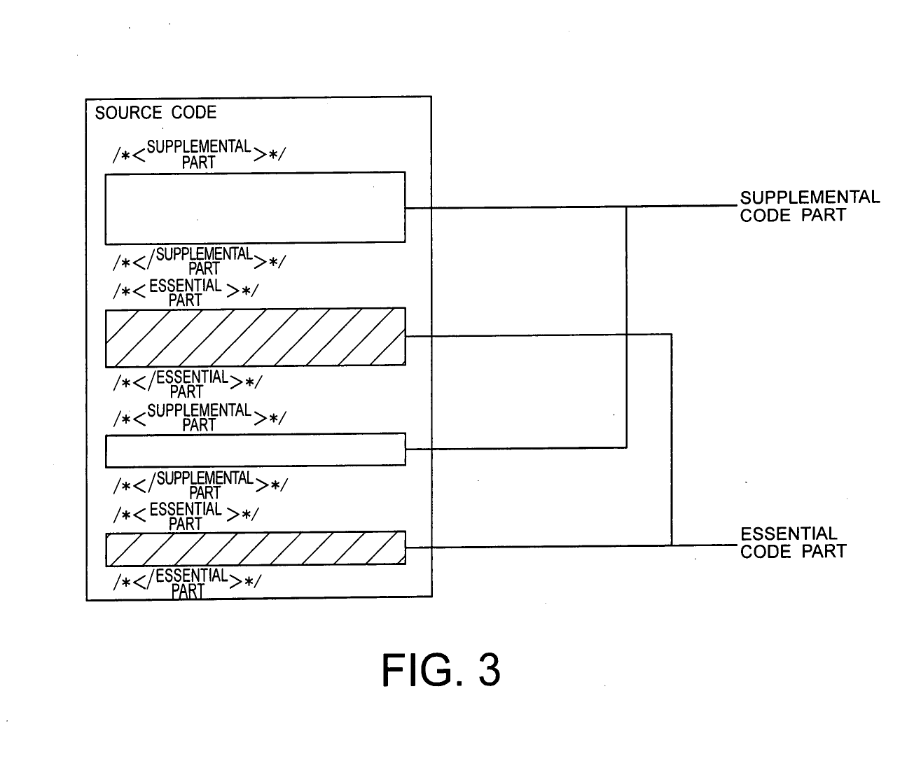

In the component record unit 10, a source code (Refer to FIG. 3) of a software component, management information (such as a component name, a version number, and an author name) of the software component are recorded.

In FIG. 2, a component(a) 11 and a component(b) 12 created by author X are recorded as a version number Ver.1.0. A component (c) 13 created by author Y is recorded as a version number Ver.1.2, a component(d) 14 created by author Y is recorded as a version number Ver.1.1, and a component(e) 15 created by author Z is recorded as a version number Ver.1.3. In this case, the version number except for Ver.1.0 represents that this component has already been modified at least one time.

In the user-side software record unit 20, a user-side software which utilizes a software component recorded in the component record unit 10 is recorded in relation to the software component.

For example, in FIG. 2, the user-side software A utilizes software components (a) (b) (c) recorded in the component record unit 10. In a record column 21 of the user-side software A, management information of these software component ((a)211, (b)212, (e)213) is recorded.

In the same way, the user-side software B utilizes software components (b) (c) recorded in the component record unit 10. In a record column 22 of the user-side software B, management information of these software component ((b)221, (c)222) is recorded.

Furthermore, in the same way, the user-side software C utilizes software components (d) recorded in the component record unit 10. In a record column 23 of the user-side software C, management information of these software component ((d)231) is recorded.

Even if each component name of a plurality of software component is the same (as a name of original software component) each software component of different version is often used in different user-side software. Accordingly, in the present embodiment, modification history of the software component in each user-side software is managed by the version number. In order to clarify this aspect, in FIG. 2, as for a plurality of software components having the same name, a different sign (number) is assigned to each software component for each user-side software (For example, as for the component (b), 212 and 221 are respectively assigned.). Furthermore, in the component record unit 10 and the user-side software record unit 20, a different sign is assigned to two software components of the same name (For example, as for the component (a), 11 and 211 are respectively assigned.).

In the registration-update unit 30, a source code and management information of a software component input from a user (an author or an updater of the software component) are analyzed, and the software component is registered/updated in at least one of the component record unit 10 and the user-side software record unit 20. Operation of the registration-update unit 30 is explained afterwards.

In the information notification unit 40, various information is notified to each maintainer (user) of user-side software recorded in the component record unit 10. Especially, when the registration-update unit 30 decides that a modification (change) part of a software component modified is an essential part, the modification information is notified to each maintainer (each user-side software).

FIG. 3 is a schematic diagram of one example of a source code of the software component processed by the software component management apparatus 1.

Usually, a source code of a software component has distinctly an essential part and a supplemental part. The essential part is a core part of function realized by the software component. The supplemental part is a part not the core part, such as a part to execute error-correction processing, a part to create operation parameter, a part to check input/output limit, and a part to control user-interface.

In the source code of FIG. 3, in order to clarify the essential part, a comment sentence (/*<essential part>*/) is inserted just before a start position of the essential part, and a comment sentence (/*</essential part>*/) is inserted just after an end position of the essential part. In the same way, in order to clarify the supplemental part, a comment sentence (/*<supplementalpart>*/) is inserted just before a start position of the supplemental part, and a comment sentence (/*</supplemental part>*/) is inserted just after an end position of the supplemental part.

In general, in case of using a software component by a plurality of user-side software, the essential part is commonly used among the plurality of user-side software. The supplemental part is often modified to a form suitable for each user-side software and differently used by each user-side software.

In case of modifying (changing) the essential part, this modification affects all user-side software, and influence level by the modification is great. On the other hand, in case of modifying the supplemental part, this modification often affects a few user-side software only, and influence level by the modification is relatively low.

For example, in a predetermined user-side software, modification added to the essential part for function-extension or bug-elimination is often necessary for other user-side software to commonly reflect. On the other hand, in the predetermined user-side software, modification added to the supplemental part is often peculiar to the predetermined user-side software, and not necessary for other user-side software.

As shown in FIG. 3, in the software component management apparatus 1 of the present embodiment, the software component having a source code of which essential part and supplemental part are discriminately described is registered.

It is most effective that an author of the software component describes the source code by discriminating the essential part and the supplemental part because the author knows the contents of the original software component. However, an operator who describes the source code is not limited to the author.

Furthermore, concrete method to discriminately describe the essential part and the supplemental part is not limited to a method by the comment sentence in FIG. 3. Briefly, the software component management apparatus 1 can mechanically (automatically) read the essential part and the supplemental part, and description of the source code does not affect the execution of the software component. In this condition, various methods to describe the source code can be applied.

(2) Method for managing a software component

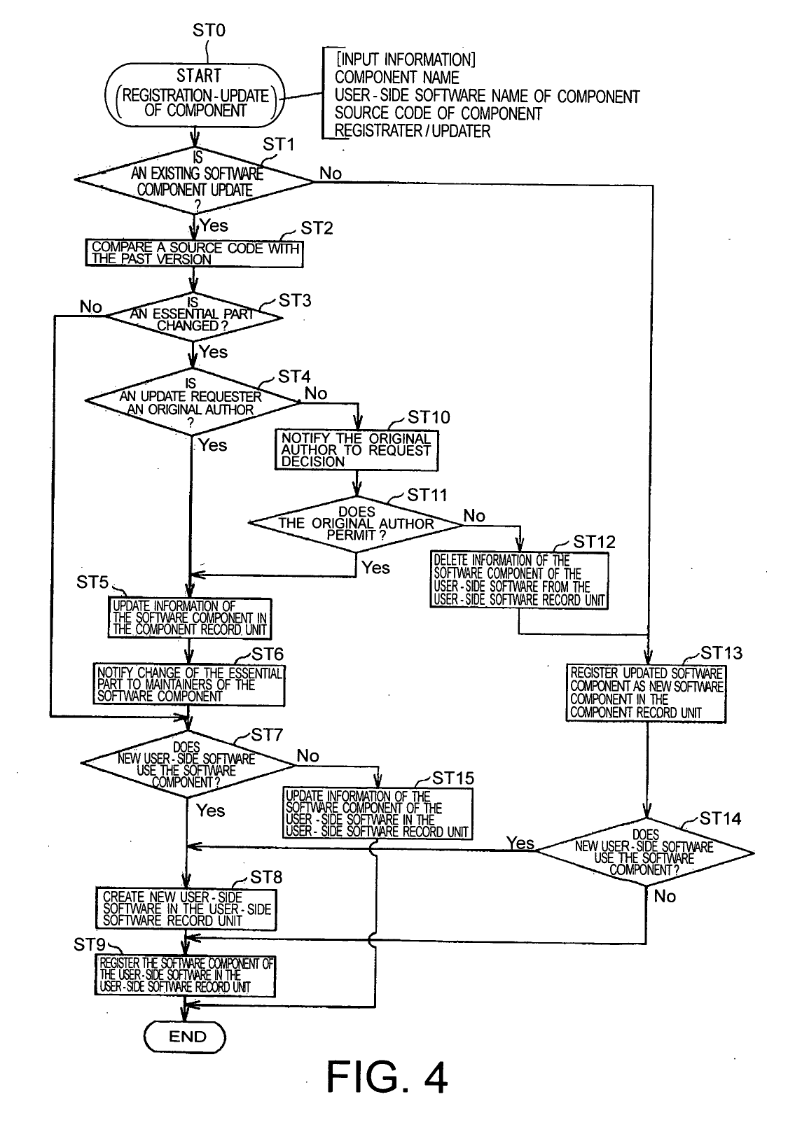

Next, operation of the software component management apparatus 1 (constructed as above-mentioned) is explained. FIG. 4 is a flow chart of processing of the software component management method. The processing in this flow chart is executed by the registration-update unit 30 (refer to FIG. 2) in the software component management apparatus 1.

First, at STO, data related to a software component created by a user (the author or the updater of a software component) of the software component management apparatus 1 is input. For example, the data includes a name of a software component, a name of a user-side software which utilizes the software component, a source code of the software component, and a name of the author (or updater).

Input form of the data is not especially limited. For example, input form via an electrical communication circuit (such as LAN, Internet, or leased line) may be applied. Alternatively, the input form via a memory medium (such as an optical disk, a magnetic disk, or a semiconductor memory) may be applied.

Next, at ST1, it is decided whether the input software component is a software component to update in the component record unit 10 and the user-side software record unit 20, or a new software component to register in the component record unit 10 and the user-side software record unit 20. This decision is executed by checking each name of the software components recorded.

In the case of a new software component, processing is forwarded to new registration (ST13). On the other hand, in the case of an update of a software component recorded, processing is forwarded to update (ST2).

At ST2, a source code of the input software component is compared with a source code of the registered software component having the same name as the input software component. A modification part of the input software component is then decided to be an essential part or a supplemental part.

As shown in FIG. 3, the source code discriminately has the essential part and the supplemental part. By comparing a source code of the input software component with a source code of the registered software component having the same name as the input software component, a difference part between the input software component and the registered software component is detected. Accordingly, a modification part (change part) of the input software component is decided to be an essential part or a supplemental part.

In case that the modification part of the software component is the supplemental part (No at ST3), processing is forwarded to ST7.

At ST7, it is decided whether a user-side software which uses the modified software component is already registered in the user-side software record unit 20 or new user-side software.

In case that the user-side software is already registered in the user-side software record unit 20 (No at ST7), management information of the modified software component related to the registered user-side software is updated (ST15).

On the-other hand, in case that the user-side software is new user-side software (Yes at ST7), a record column of the new user-side software is created in the user-side software record unit 20 (ST8). This new user-side software is registered in the record column of the user-side software record unit 20.

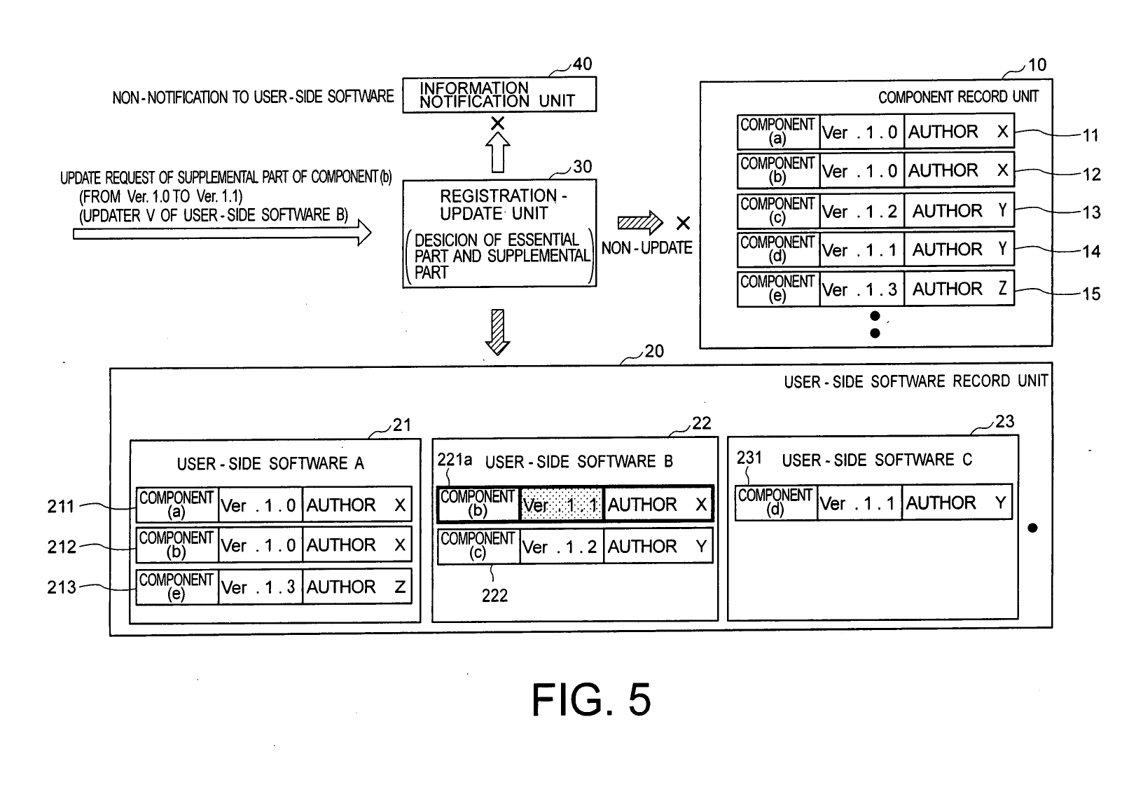

FIG. 5 shows an example to explain operation in case of updating a software component of which modification part is a supplemental part.

In this example, an operator (updater) V of the user-side software B modifies a component (b) in software components used by the user-side software B. Concretely, the supplemental part of the component (b) is only modified, and a version number of the component (b) is updated from Ver.1.0 to Ver.1.1.

Processing of the registration-update unit 30 is forwarded from ST3 to ST7 because the modification part is a supplemental part. Furthermore, the processing is forwarded from ST7 to ST15 because the user-side software B is already registered in the user-side software record unit 20. In management information 221a of the component (b) in the record column 22 of the user-side software B, the version number is updated from Ver.1.0 to Ver.1.1.

In this way, in case of updating a software component in the user-side software record unit 20, management information of the user-side software B which modified the software component at that time is only updated, and management information of another user-side software is not updated. For example, the component (b) is used by a user-side software A. However, in the user-side software A, the component (b) is not modified (changed) and it is used as Ver.1.0. Accordingly, management information of the component (b) 212 of the user-side software A is not updated.

Furthermore, in case that a modification (change) part of the component (b) is a supplemental part, management information of the component (b) in the component record unit 10 is not updated. As explained afterwards, management information of a component in the component record unit 10 is only updated in case that the essential part of the component is modified (changed).

In the component record unit 10, management information of a software component as a base (original software component) is stored as one component. On the other hand, in the user-side software record unit 20, the software component as a branch (modified software component) is stored in correspondence with each user-side software. The branch means a modification version of the base by the user-side software. Briefly, the component record unit 10 manages the base of the software component, and the user-side software record unit 20 manages the branch of the software component. Accordingly, both managements are effectively shared.

Furthermore, in case that a modification part of the software component is a supplemental part, the information notification unit 40 does not notify information of the modification part to other user-side software. As mentioned-above, modification of the supplemental part is nearly peculiar to the predetermined user-side software. If such modification of the supplemental part is notified to all user-side software, each user-side software often receives the notification not so important (not always related to each user-side software), and each user-side software is confused. As a result, efficiency in development step of the user-side software falls, and smooth application in use step of the user-side software is prevented.

Accordingly, in case that the modification part is the supplemental part, non-notification to another user-side software rather improves development efficiency of the user-side software, and smooth application of the user-side software can continue.

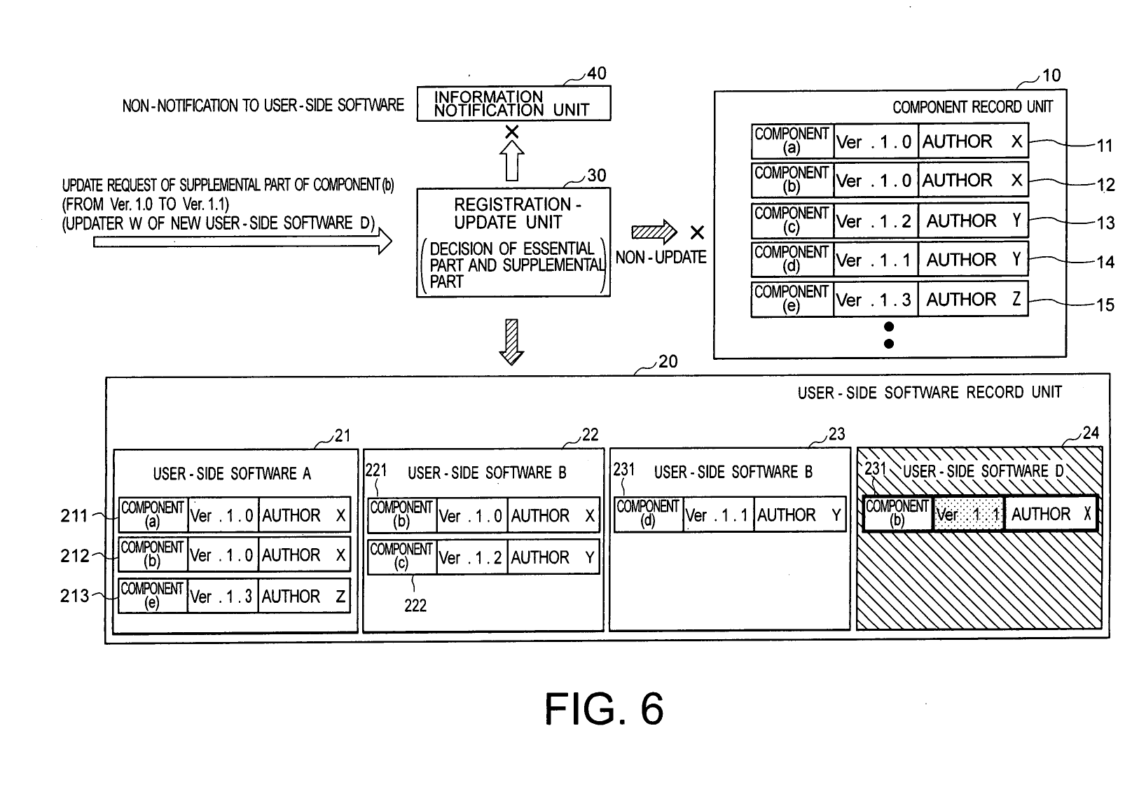

FIG. 6 shows an example to explain operation of the registration update unit 30, in case that a modification part of a software component is a supplemental part and a user-side software which modified the software component is not registered.

Feature to change a supplemental part of the component (b) and update the version number from Ver.1.0 to Ver.1.1 is the same as in the example of FIG. 5. However, feature that an updater W is an operator of new user-side software D is different from FIG. 5.

In this case, the registration-update unit 30 creates a record column (user-side software D 24) of new user-side software in the user-side software record unit 20 (ST8 in FIG. 4). After that, management information of the component (b) as the version number Ver.1.1 is registered in the user-side software D.

Next, update operation in case that the modification part of the software component is an essential part is explained. In case that the modification part is an essential part (ST3 in FIG. 4), an operator (user) who updates a software component is decided to be an author of an original version of the software component (ST4).

In general, the author of the original version may have the most knowledge of the contents of the software component. If the operator is the author, update of the software component is permitted. In this case, the modification part is an essential part. Accordingly, a source code and management information of the software component (base) in the component record unit 10 are updated (ST5).

Furthermore, modification of an essential part of the software component often affects other user-side software (Same modification of this software component should be executed in another user-side software). Accordingly, the information notification unit 40 notifies information of change of essential part to all user-side software which utilize this software component (ST6).

Processing from ST7 in FIG. 4 is the same between the case of change of essential part and the case of change of supplemental part. Accordingly, its explanation is omitted.

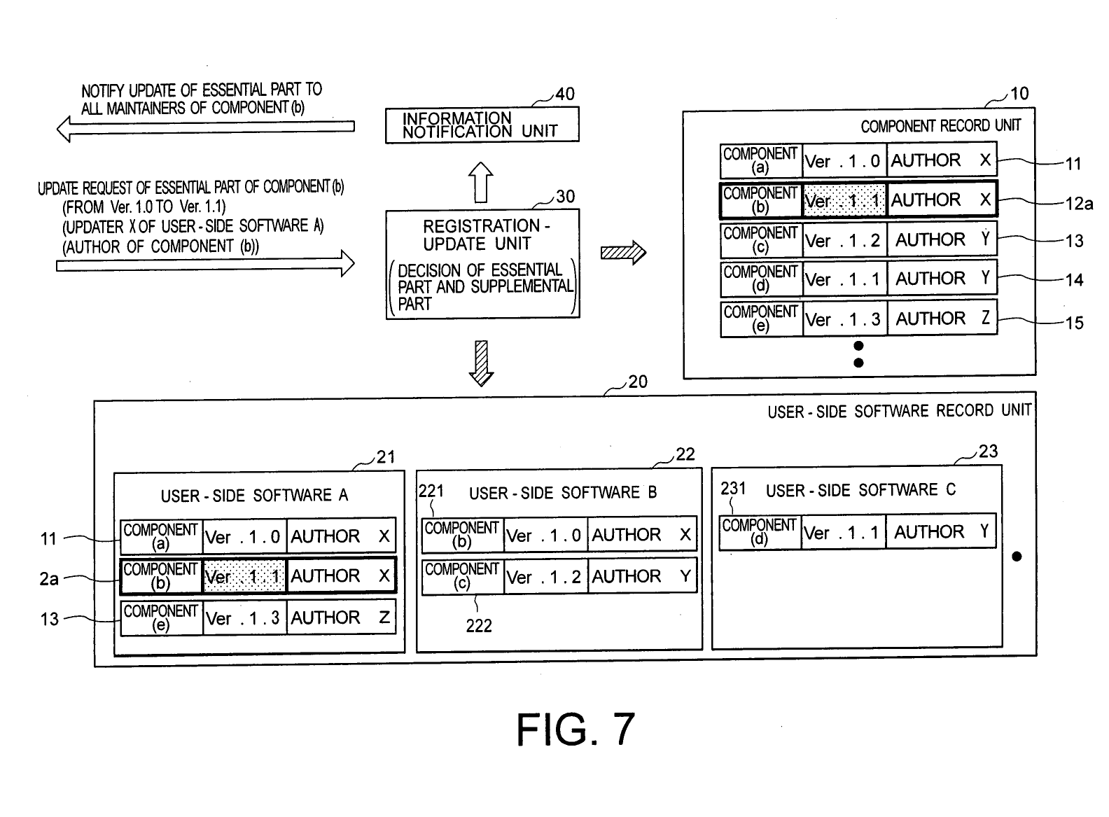

FIG. 7 shows an example to explain the above-operation of the registration-update unit 30 in case of change of the essential part. Concretely, the essential part of the component (b) is modified (changed), and an operator (updater) is an author A of original version of the component (b).

In this case, the registration-update unit 30 updates (modifies) a source code of the component (b) registered in the component record unit 10, and updates a version number in management information of the component (b) from Ver.1.0 to Ver.1.1.

Furthermore, as for all maintainers (user-side software) who utilize the component (b), the information notification unit 40 notifies information that the essential part of the component (b) is updated. In this notification, the source code updated may be added.

For example, an essential part of a software component is changed to extend a function or fix a bug of the software component. This modification is possibly important (necessary) for all user-side software which use the software component. In response to this notification, the maintainer (user-side software) can quickly understand the change contents by inquiring to the updater or analyzing the attached source code. As a result, development efficiency or use efficiency of the user-side software can be improved.

Update of management information in the user-side software record unit 20 is executed for only a user-side software (In FIG. 7, the user-side software A) of the updater. As for other user-side software, each user-side software decides to adopt this change. After receiving an update request from another user-side software, management information of the another user-side software in the user-side software record unit 20 is updated.

If the change part of a software component is an essential part and the updater is not an author of an original version of the software component (No at ST4), a request for permission to update the software component is sent to the author (ST10). For example, the information notification unit 40 may ask the user-side software of the author or may ask the author by E-mail.

In response to the inquiry, the author decides whether update of the software component is permitted, and replies the decision result via the information notification unit 40 or E-mail.

The registration-update unit 30 decides whether update-permission is received from the author (ST11). In case of receiving update-permission, update processing of the software component is executed in the same way as the case that the updater is the author (steps after ST5).

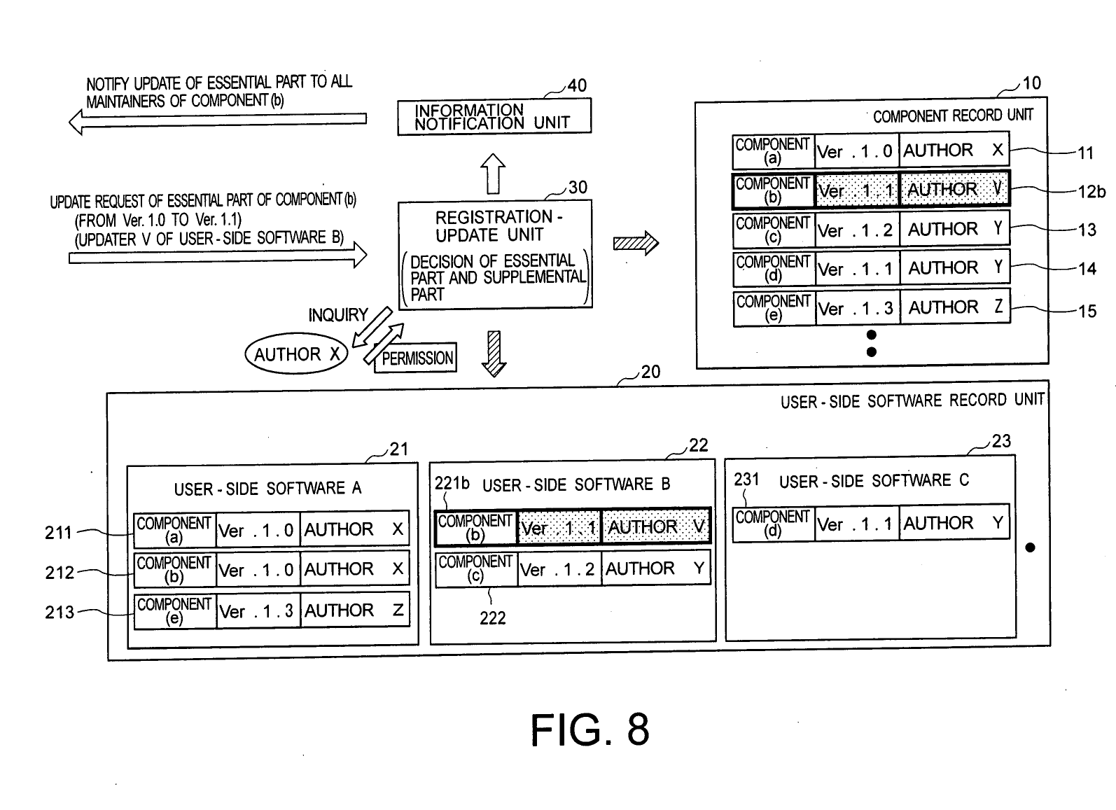

FIG. 8 shows an example to explain the above-operation in case that update request of the essential part of a component (b) is not by an author X but by an updater V of a user-side software B.

The registration-update unit 30 inquires update-permission of the component (b) to the author X. In case of receiving update-permission from the author A, the registration-update unit 30 updates the component (b) registered in the component record unit 10. In this case, by change of the essential part, substantial author of the component (b) may be changed from X to V. In FIG. 8, in addition to update of the version number from Ver.1.0 to Ver.1.1, the author name is updated from X to V.

Furthermore, the registration-update unit 30 sends information that the essential part of the component (b) is updated to all maintainers (user-side software) of the component (b) via the information notification unit 40.

In case of update of management information in the user-side software record unit 20, in the same way as in other examples, management information of the component (b) of the user-side software which modified the component (b) (actually installs the modified component (b)) is only updated.

On the other hand, assume that a user V except for an author X modifies the essential part of the software component and the author X is asked for update-permission. If update-permission from the author X is not obtained (No at ST11), the modified software component is regarded as new software component created by the user V.

Briefly, in the user-side software record unit 20, management information of the software component (update-permission from the author is not obtained) of the user-side software of the user V is deleted (ST12). In the component record unit 10, a source code of the software component of which essential part is modified as new software component, and the management information are newly registered (ST13).

Furthermore, in the user-side software record unit 20, in place of the deleted management information, management information of the new software component is recorded in the column of the user-side software of the user V (ST14, ST9).

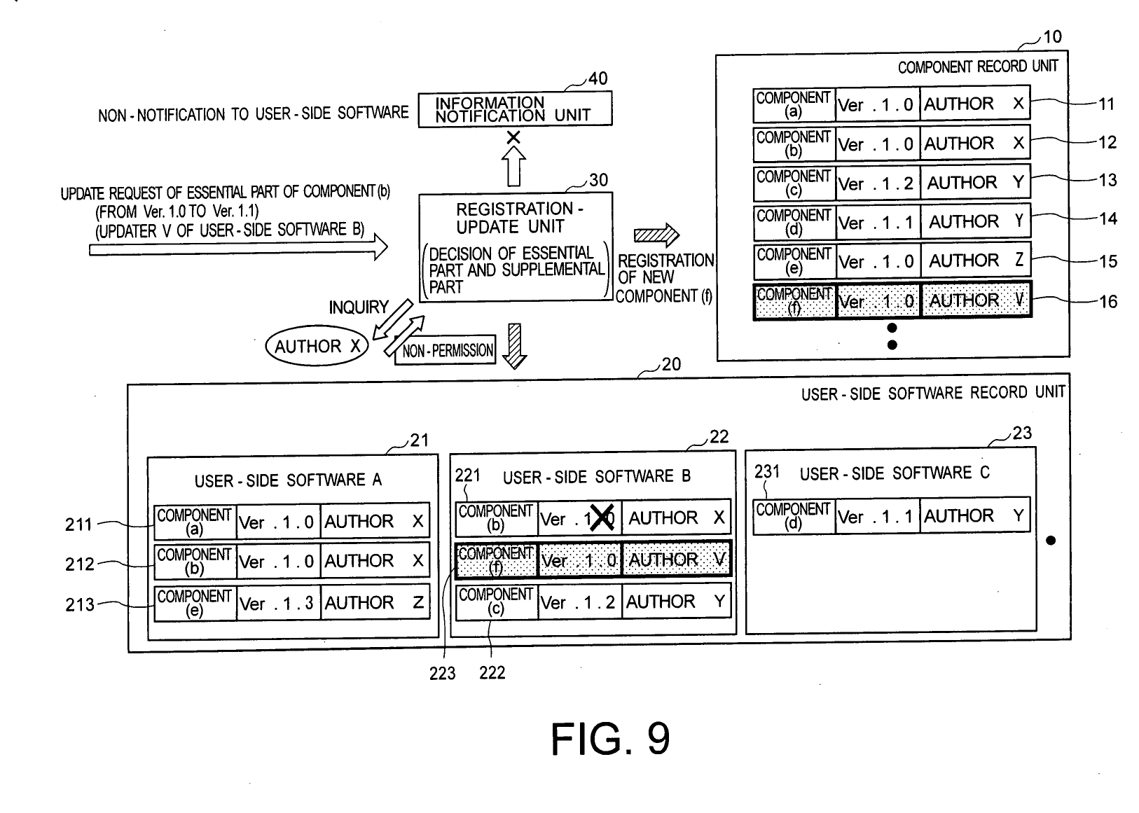

FIG. 9 is a concrete example to explain operation in case of not obtaining update-permission from the author. In FIG. 9, an updater who changed the essential part of the component (b) is not the author X of the component (b) but a user V (maintainer) of the user-side software B. Furthermore, update-permission of the component (b) is not obtained from the author X.

In this case, in the component record unit 10, a source code and management information 12 of the (original) component (b) remain as the version number Ver.1.0 without updating.

On the other hand, the component (b) of which essential part is changed is registered as new software component (f) 16 in the component record unit 10. In this case, a version number of the new software component (f) is Ver.1.0, and the user V (updater) is registered as an author of the component (f).

Furthermore, in the user-side software B of the user-side software record unit 20, the component (b) 221 is deleted, and the new component (f) 223 is registered.

Originally, as for the component (b), all parts (including the essential part) are not changed. Accordingly, as for all users (user-side software) which utilize the component (b), notification is not sent.

As mentioned-above, in the software component management apparatus 1 of the present invention, a source code and management information of a software component (base) are registered in the component record unit 10. Furthermore, management information of a software component (branch) is registered in correspondence with each user-side software (which uses the software component) in the user-side software record unit 20. Accordingly, software components can be effectively managed without omission.

Furthermore, in case of changing the software component registered, it is decided whether the changed part is an essential part or a supplemental part of the software component. If the changed part is the essential part, change of the essential part is notified to all user-side software (users) which utilize this software component. If the changed part is a supplemental part, a notice may not be sent. Accordingly, flood of unnecessary information may be prevented, and only necessary information can be exactly provided to other users. As a result, development efficiency improves in development step of the user-side software, and smooth use is promoted in application step of the user-side software.

Furthermore, when a software component is modified (changed) by a user except for an author of an original version of the software component, only if update-permission from the author is obtained, the software component is updated by modification. Accordingly, update of the software component by erroneous modification can be previously prevented.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MM (middle ware software) such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for managing a software component, comprising:
a component record unit configured to record a plurality of software components, each software component having an essential part and a supplemental part;
a user-side software record unit configured to record a plurality of user-side softwares, each user-side software being related to at least one software component recorded in said component record unit;
a registration-update unit configured to decide whether a modification part of a software component recorded in said component record unit is the essential part or the supplemental part, and to update information of at least one of said component record unit and said user-side software record unit based on a decision result; and
an information notification unit configured to notify the modification part to the user-side software related to the software component modified if the modification part is the essential part.

2. The apparatus according to claim 1, wherein, if the modification part is the essential part and an operator of the modification part is an author of the software component modified,
said registration-update unit updates the information of the software component modified in said component record unit, and
if the modification part is the essential part and the operator of the modification part is not the author of the software component modified,
said registration-update unit asks the author whether modification of the software component is permitted.

3. The apparatus according to claim 2, wherein,
if the author permits the modification of the software component,
said registration-update unit updates the information of the software component modified in said component record unit.

4. The apparatus according to claim 2, wherein,
if the author does not permit the modification of the software component,
said registration-update unit registers the software component modified as a new software component in said component record unit.

5. The apparatus according to claim 4, wherein,
when the new software component is used by another user-side software except for the user-side softwares recorded in said user-side software record unit,
said registration-update unit registers the another user-side software as a new user-side software related to the new software component in said user-side software record unit.

6. The apparatus according to claim 1, wherein,
if the modification part is the supplemental part,
said registration-update unit updates the information of the software component modified, related to a user-side software which modified the software component in said user-side software record unit.

7. The apparatus according to claim 6, wherein,
when the software component modified is used by another user-side software except for the user-side softwares recorded in said user-side software record unit,
said registration-update unit registers the another user-side software as a new user-side software related to the software component modified in said user-side software record unit.

8. The apparatus according to claim 1, wherein
the software component is described as a source code, and
the source code has mark information discriminating the essential part and the supplemental part.

9. The apparatus according to claim 8, wherein
said component record unit records the source code, a name,
a version number, and an author name of each software component, and
said user-side software record unit records the name, the version number, and the author name of a software component related to the user-side software which uses the software component.

10. A method for managing a software component, comprising:
recording a plurality of software components, each software component having an essential part and a supplemental part;
recording a plurality of user-side softwares, each user-side software being related to at least one software component recorded;
deciding whether a modification part of a software component recorded is the essential part or the supplemental part;
updating at least one of the plurality of software components and the plurality of user-side softwares based on a decision result; and
notifying the modification part to the user-side software related to the software component modified if the modification part is the essential part.

11. The method according to claim 10, further comprising:
if the modification part is the essential part and an operator of the modification part is an author of the software component modified,
updating information of the software component modified in the plurality of software components; and
if the modification part is the essential part and the operator of the modification part is not the author of the software component modified,
asking the author whether modification of the software component is permitted.

12. The method according to claim 11, further comprising:
if the author permits the modification of the software component,
updating the information of the software component modified in the plurality of software components.

13. The method according to claim 11, further comprising:
if the author does not permit the modification of the software component,
registering the software component modified as a new software component.

14. The method according to claim 13, further comprising:
when the new software component is used by another user-side software except for the user-side softwares recorded,
registering the another user-side software as a new user-side software related to the new software component.

15. The method according to claim 10, further comprising:
if the modification part is the supplemental part,
updating the information of the software component modified, related to a user-side software which modified the software component.

16. The method according to claim 15, further comprising:
when the software component modified is used by another user-side software except for the user-side software recorded,
registering the another user-side software as a new user-side software related to the software component modified.

17. The method according to claim 10, wherein
the software component is described as a source code, and
the source code has mark information discriminating the essential part and the supplemental part.

18. The method according to claim 17, wherein
the information of the plurality of software components includes the source code, a name, a version number, and an author name of each software component, and
the information of the plurality of user-side softwares includes the name, the version number, and the author name of the software component related to the user-side software which uses the software component.

19. A computer readable medium having a software component comprising:
a source code having an essential part and a supplemental part; and
a mark information added to the essential part and the supplemental part for causing a computer to discriminate between the essential part and the supplemental part.

20. The computer readable medium component according to claim 19,
wherein the mark information respectively represents a start position and an end position of the essential part, and a start position and an end position of the supplemental part.
